(19) United States
(12) Patent Application Publication
(10) Pub. No.: US 2013/0212101 A1
(43) Pub. Date: Aug. 15, 2013

(54) PORTLET PROCESSING APPARATUS, PORTAL SERVER, PORTAL SYSTEM, PORTLET PROCESSING METHOD AND RECORDING MEDIUM

(71) Applicant: NEC Corporation, (US)

(72) Inventor: Yusuke Okuno, Tokyo (JP)

(73) Assignee: NEC Corporation, Tokyo (JP)

(21) Appl. No.: 13/755,680

(22) Filed: Jan. 31, 2013

(30) Foreign Application Priority Data
Feb. 9, 2012 (JP) 2012-026281

(51) Int. Cl. G06F 17/30

(52) U.S. Cl. CPC G06F 17/30283
USPC 707/736

(57) ABSTRACT

Provided is a technology which enables recommendation of a portlet providing the function of being a gateway to contents frequently browsed by users without imposing any burden on users' work.

The technology includes: a means that, on the basis of browsing data of a user, specifies at least one content which is frequently browsed by the user; a means that stores therein a content correspondence condition for a portlet which can be arranged on a portal page; and a means that outputs information representing a portlet on which a certain content, being included in the at least one content specified, and having been determined as a content satisfying the content correspondence condition, is set so as to be allowed to be referred to, the information being outputted as a recommended portlet which is recommended to be arranged on a portal page of the user.

This application is based upon and claims the benefit of priority from Japanese Patent Application No. 2012-026281, filed on Feb. 9, 2012, the disclosure of which is incorporated herein in its entirety by reference.

### TECHNICAL FIELD

The present invention relates to a technology for processing a portlet arranged on a portal.

### BACKGROUND ART

Known examples of services on the Web (World Wide Web) include a so-called portal (a portal service or a portal site). This portal provides a website which is a gateway or a front door for users to access for contents on the Web.

Further, most of the portals make it possible for one or more portlets to be arranged on their pages. This portlet is an attachable and detachable component for a user interface, and is arranged on a portal. Known examples of a portlet include (a) a portlet for indicating a list of shortcuts (hyperlinks) to other contents, (b) a portlet for indicating other contents themselves, (c) a portlet for indicating contents based on RSS (RDF Site Summary, Rich Site Summary or Really Simple Syndication) or Atom (Atom Syndication Format), which are delivered by other websites. For such a portlet, sometimes, referred-to contents and the arrangement of portlets on a page can be customized by a user. A user of a portal can improve the efficiency of accesses for highly frequently browsed contents (that is, the convenience of a portal) by customizing the portal. Known examples of such a customization of a portal include: indicating, on a portlet, a list of shortcuts to highly frequently browsed contents; indicating the content of pages of highly frequently browsed contents; and arranging frequently used portlets at a higher portion of a portal.

In this way, users need to customize their portals in accordance with their own interests and/or contents of work, in order to improve the convenience of their portals. Such customization work, unfortunately, results in a burden on a user. Moreover, in order to customize a portal, knowledge on ‘kinds of available portlets’ and ‘appropriate usage methods and setting methods for portlets’ is necessary. In order to improve the convenience of a portal, a user has to learn these pieces of knowledge. Learning of such knowledge also results in a burden on a user.

For this reason, as one of related technologies which enable improvement of the convenience of such a portal without imposing any burden on users' work, there has been a technology which enables an automatic allocation change of portlets in accordance with individual users' usage patterns (refer to, for example, Japanese Patent Application Unexamined Publication No. 2005-346318). This related technology calculates the degrees of relevancy among portlets, on the basis of keywords extracted from content information to which individual portlets refer, and portlet display screens. Further, this related technology arranges portlets each having a high degree of relevancy with a portlet currently selected by a user, near by the currently selected portlet.

Moreover, as another one of related technologies, there has been a technology which recommends, to a user, portlets each being different from portlets currently arranged in a portal, and having a high degree of relevancy with the portlets currently arranged in the portal (refer to, for example, Japanese Patent Application Unexamined Publication No. 2011-186732). This related technology stores, in advance, the degrees of relevancy among individual portlets which are registered as portals which can be arranged on a portal. Further, this related technology proposes portlets, which have high evaluation values based on the degrees of relevancy with portlets already arranged on a portal, from among portlets currently not arranged on the portal.

Moreover, as another one of related technologies, there exists a technology which indicates a personal menu on a portal, the menu including links to contents frequently accessed by a user (refer to, for example, Japanese Patent Application Unexamined Publication No. 2003-345827). This related technology indicates a personal menu on a portal, the menu including links to first layer websites which have been selected on the basis of an access log of a user's accesses for contents, and links to second layer websites which have been accessed within a predetermined period of time from an access to any one of the first layer websites.

Moreover, as another one of related technologies, there exists a technology which, upon reception of a content from a server, having been requested by a client, converts the received content into a portal, and sends the resultant portal to the client (refer to, for example, Japanese Patent Application Unexamined Publication No. 2005-284978). This related technology stores, in advance, a user's history of accesses for contents on the Web as learning data. Further, this related technology embeds links to contents, each having a high score in an evaluation based on the leaning data, into a content having been received from a server, and thereby, converts the content into a portal.

Moreover, as another one of related technologies, there exists a technology which incorporates a history of user operations into a promoted content provided by EPG (Electronic Program Guide) portlet (refer to, for example, Japanese Patent Application Unexamined Publication No. 2005-12282). When a user brows a content which is frequently accessed by the user, this related technology stores information related to this event into an operation history information DB (Data Base). Further, when determining promoted contents, this related technology determines, by referring to this operation history information DB, that the user is interested in the content, and presents contents correlated with the content as promoted contents.

### SUMMARY

An exemplary object of the present invention is to provide a portlet processing apparatus, a portlet server, a portal system, a portlet processing method and a computer program which enable recommendation of a portlet providing the function of being a gateway to contents frequently browsed by users without imposing any burden on users' work.

A portlet processing apparatus according to an aspect of the present invention includes: a browsing data acquisition unit that acquires browsing data representing a user's history of browsing of contents; a browsing data storage unit that stores the browsing data therein; a browsing data analysis unit that, on the basis of the browsing data, specifies at least one content of the contents, which is frequently browsed by the user; a portlet content correspondence information storage unit that, for a portlet which can be arranged on a portal page of the user, store a content correspondence condition for the portlet, representing a condition for specifying a content of the contents, allowed to be referred to on the portlet; and a portlet recommendation unit that determines a certain content satisfying the content correspondence condition for the portlet, stored in the portlet content correspondence information storage unit, from among the specified at least one content on the basis of the browsing data, and outputs information representing the portlet on which the certain content having been determined as a content satisfying the content correspondence condition for the portlet is set so as to be allowed to be referred to, the information being outputted as a recommended portlet which is recommended to be arranged on the portal page of the user who has browsed the certain content.

A portlet processing method according to another aspect of the present invention includes: acquiring browsing data representing a user's history of browsing of contents; on the basis of the browsing data, specifying at least one content of the contents, which is frequently browsed by the user; for a portlet which can be arranged on a portal page of the user, by retaining a content correspondence condition for the portlet, representing a condition for specifying a content of the contents, allowed to be referred to on the portlet, determining a certain content satisfying the content correspondence condition for the portlet from among the specified at least one content on the basis of the browsing data, and outputting information representing the portlet on which the certain content having been determined as a content satisfying the content correspondence condition for the portlet is set so as to be allowed to be referred to, the information being outputted as a recommended portlet which is recommended to be arranged on the portal page of the user who has browsed the certain content.

A nonvolatile recording medium according to another aspect of the present invention records a computer program which causes a computer to execute the processing including the steps of; a browsing data acquisition step of acquiring browsing data representing a user's history of browsing of contents; a browsing data analysis step of, on the basis of the browsing data, specifying at least one content of the contents, which is frequently browsed by the user; and a portlet recommendation step of, for a portlet which can be arranged on a portal page of the user, by retaining a content correspondence condition for the portlet, representing a condition for specifying a content of the contents, allowed to be referred to on the portlet, determining a certain content satisfying the content correspondence condition for the portlet from among the specified at least one content on the basis of the browsing data, and outputting information representing the portlet on which the certain content having been determined as a content satisfying the content correspondence condition for the portlet is set so as to be allowed to be referred to, the information being outputted as a recommended portlet which is recommended to be arranged on the portal page of the user who has browsed the certain content.

### BRIEF DESCRIPTION OF THE DRAWINGS

Exemplary features and advantages of the present invention will become apparent from the following detailed description when taken with the accompanying drawings in which:

FIG. 1 is a diagram illustrating a hardware configuration of a portlet processing apparatus according to a first exemplary embodiment.

FIG. 2 is a block diagram illustrating function blocks of a portlet processing apparatus according to a first exemplary embodiment.

FIG. 3 is a diagram illustrating an example of browsing data according to a first exemplary embodiment.

FIG. 4 is a diagram illustrating an example of portlet content correspondence information according to a first exemplary embodiment.

FIG. 5 is a flowchart illustrating operations of a portlet processing apparatus according to a first exemplary embodiment.

FIG. 6 is a block diagram illustrating a configuration of a portal system according to a second exemplary embodiment.

FIG. 7 is a block diagram illustrating function blocks of each apparatus constituting a portal system according to a second exemplary embodiment.

FIG. 8 is a flowchart illustrating browsing data recording operations of a portal system according to a second exemplary embodiment.

FIG. 9 is a flowchart illustrating recommended portlet determination operations of a portal system according to a second exemplary embodiment.

FIG. 10 is a flowchart illustrating recommended portlet presentation operations of a portal system according to a second exemplary embodiment.

FIG. 11 is a flowchart illustrating details of browsing data analysis processing of a portal system according to a second exemplary embodiment.

FIG. 12 is a flowchart illustrating details of recommended portlet storage processing of a portal system according to a second exemplary embodiment.

FIG. 13 is a diagram illustrating an example of a portal page according to a second exemplary embodiment.

FIG. 14 is a diagram illustrating an example of a portal page on which recommended portlets are arranged by a portal system, according to a second exemplary embodiment.

FIG. 15 is a block diagram illustrating a configuration of a portal system according to a third exemplary embodiment.

FIG. 16 is a block diagram illustrating function blocks of a portal server according to a third exemplary embodiment.

FIG. 17 is a flowchart illustrating recommended portlet presentation operations of a portal page development work supporting system according to a third exemplary embodiment.

FIG. 18 is a block diagram illustrating the configuration of a recording medium.

### EXEMPLARY EMBODIMENT

Hereinafter, exemplary embodiments will be described in detail with reference to the drawings.

### First Exemplary Embodiment

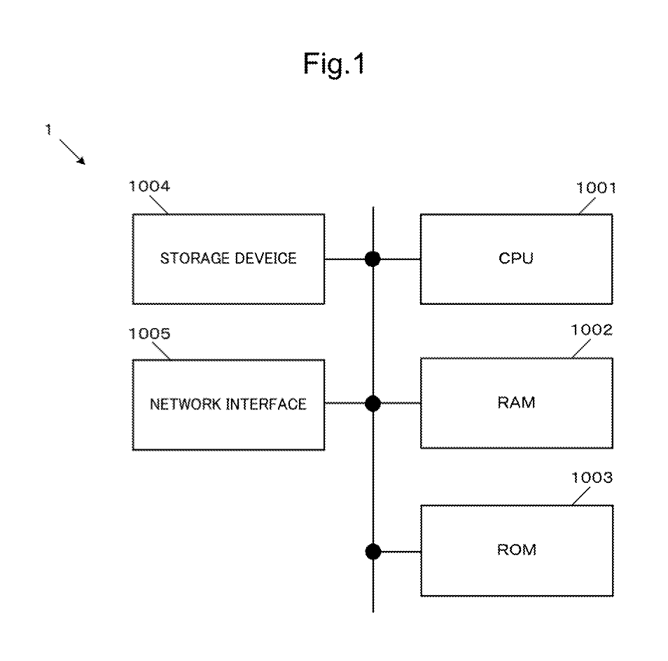

A hardware configuration of a portlet processing apparatus 1 as a first exemplary embodiment is illustrated in FIG. 1. In FIG. 1, the portlet processing apparatus 1 includes a computer apparatus provided with a CPU (Central Processing Unit) 1001, a RAM (Random Access Memory) 1002, a ROM (Read Only Memory) 1003, a storage device 1004, such as a hard disk, and a network interface 1005.

The ROM 1003 and the storage device 1004 store therein computer programs and various data for causing the computer apparatus to function as the portlet processing apparatus 1 according to this exemplary embodiment.

The CPU 1001 reads the computer programs and the various data stored in the ROM 1003 and the storage device 1004 into the RAM 1002, and executes the computer programs.

The network interface 1005 is a module for communicating with other apparatuses via networks.

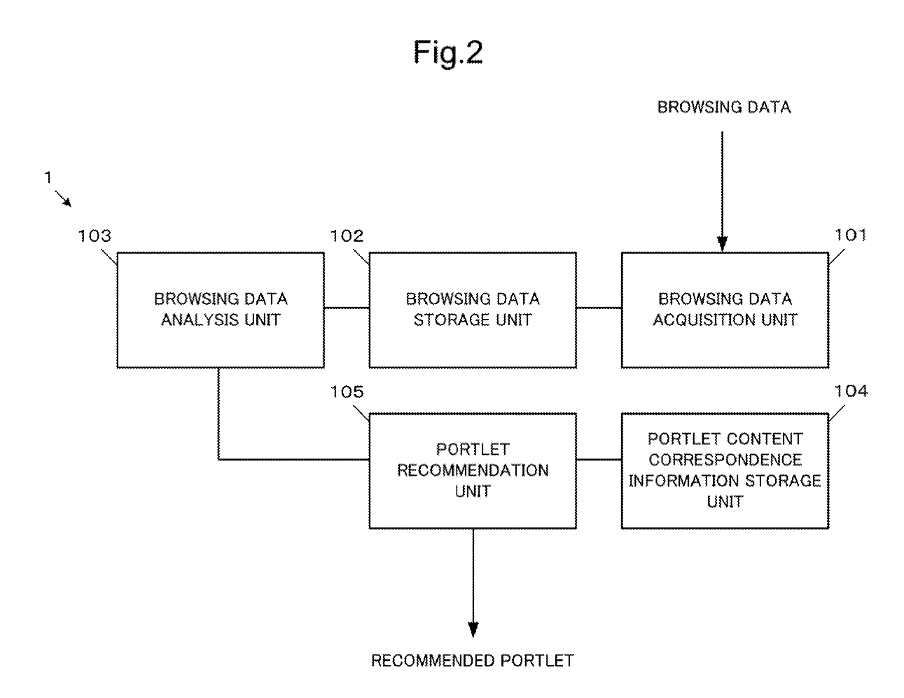

Next, a configuration of function blocks of the portlet processing apparatus 1 is illustrated in FIG. 2. In FIG. 2, the portlet processing apparatus 1 includes a browsing data acquisition unit 101, a browsing data storage unit 102, a browsing data analysis unit 103, a portlet content correspondence information storage unit 104 and a portlet recommendation unit 105. The browsing data acquisition unit 101 and the portlet recommendation unit 105 each include the network interface 1005, and the CPU 1001 which reads the computer programs and the various data stored in the ROM 1003 and the storage device 1004 into the RAM 1002 and executes the computer programs. Further, the browsing data analysis unit 103 includes the CPU 1001 which reads the computer programs and the various data stored in the ROM 1003 and the storage device 1004 into the RAM 1002 and executes the computer programs. Further, the browsing storage unit 102 and portlet content correspondence information storage unit 104 each include the storage device 1004. In addition, the hardware configuration of each of function blocks of the portlet processing apparatus 1 is not limited to the aforementioned configuration.

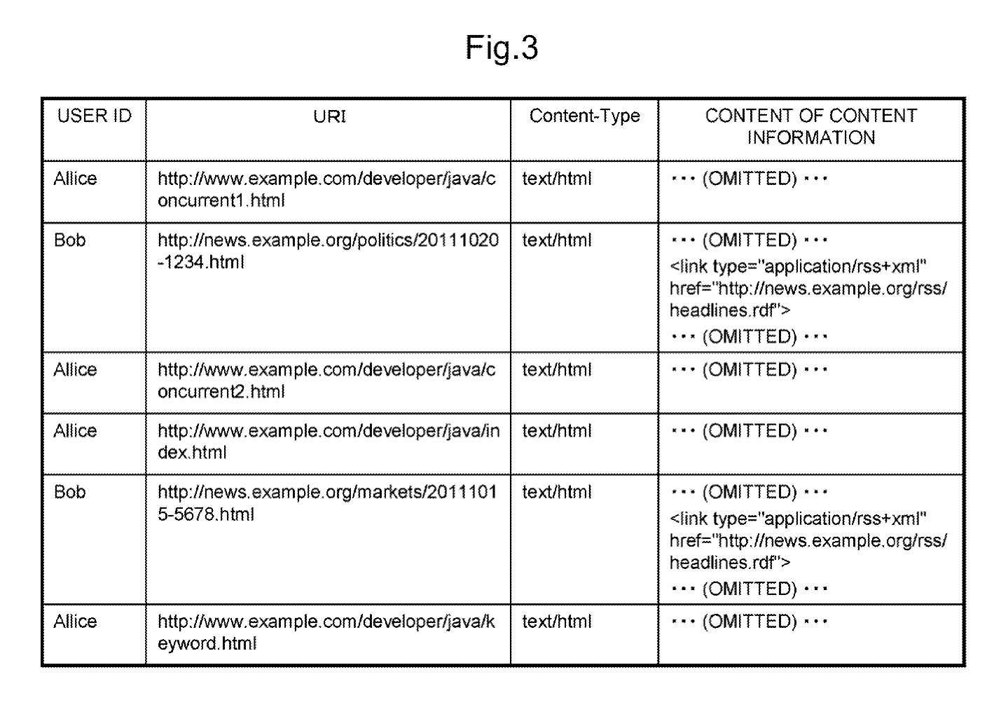

The browsing data acquisition unit 101 acquires browsing data representing a user's history of browsing of contents. Here, the content means digital data targeted for browsing performed by a user. Well-known examples of the contents include a web page, a picture, an image and document data. Such browsing data includes information representing users who have performed browsing and information in relation to browsed contents. For example, an example in which browsing data is represented by a content acquisition history in accordance with communication based on HTTP (Hypertext Transfer Protocol) is illustrated in FIG. 3. As shown in FIG. 3, the browsing data includes user IDs for identifying users, URIs (Uniform Resource Identifiers) for indicating storage locations of contents, content types for indicating the types of contents and the contents of content information.

For example, as such a history of browsing of contents, the browsing data acquisition unit 101 may acquire information stored by an application which provides the function of browsing contents. Further, in the case where such the history of browsing of contents is acquired by another apparatus which are utilized by users for their browsing of contents, the browsing data acquisition unit 101 should acquire the history of browsing of contents from such another apparatus via the network interface 1005 and the like. In addition, in the case where a history of browsing of portal pages, which will be described below, is included in such browsing data, the browsing data acquisition unit 101 acquires browsing data in which the history of browsing of portal pages has been deleted.

The browsing data storage unit 102 stores therein the history of browsing of contents having been acquired by the browsing data acquisition unit 101. For example, the browsing data storage unit 102 stores therein information shown in FIG. 3.

The browsing data analysis unit 103 specifies contents which are frequently browsed by users on the basis of the browsing data stored in the browsing data storage unit 102. Hereinafter, such contents will be also referred to as highly frequently browsed contents. For example, the browsing data analysis unit 103 may specify contents, for each of which the number of times of browsing performed by the same user within a predetermined unit period of time (i.e., a frequency of browsing) is no less than a threshold value, as highly frequently browsed contents.

The portlet content correspondence information storage unit 104 stores therein portlet content correspondence information including content correspondence conditions, for each of portlets which can be arranged on a portal page. Here, the content correspondence condition means a condition to be applied to a content which can be referred to in a relevant portlet. Further, the portal page is a page which can be browsed by an application which provides the function of browsing contents, as described above, and provides the function of being a gateway for a user to access for contents. For example, the portal page is realized as a web page which provides the function of being a gateway to contents on the Web. Further, the portlet which can be arranged on a portal page means an attachable and detachable component functioning as a user interface which is arranged on a portal page.

Such a portlet provides the function of being a gateway to referred-to contents by allowing the referred-to contents to be set therein.

For example, a portlet (a menu portlet), which provides the function of indicating a list of links to corresponding web pages, indicates a list of links to corresponding web pages, which have been set as reference destinations, in an area where the portlet itself is arranged in a portal page.

Further, a portlet (a picture portlet), which provides the function of indicating picture data, indicates picture data, which has been set as reference destinations, in an area where the portlet itself is arranged in a portal page.

For example, a portlet (an RSS portlet), which provides the function of indicating a list of RSS feeds, indicates a list of feeds delivered from RSS delivery sources, which have been set as reference destinations, in an area where the portlet itself is arranged in a portal page.

Most of such portlets each have a condition which is to be applied to effective contents as referred-to contents, depending on the content of a function provided by itself. For example, in a menu portlet, contents representing HTML (HyperText Markup Language) files are effective as referred-to contents. Further, in a picture portlet, contents representing image files are effective as referred-to contents.

Thus, the portlet content correspondence information storage unit 104 may store therein a condition on such a type of content as a content correspondence condition corresponding to each portlet. Further, the portlet content correspondence information storage unit 104 may have one or more content correspondence conditions for each portlet.

Moreover, the portlet content correspondence information storage unit 104 may store, for each portlet, data mapping information representing which data of a content satisfying the content correspondence condition is to be applied to which one of reference destinations of setting items such that the data mapping information is included in the portlet content correspondence information.

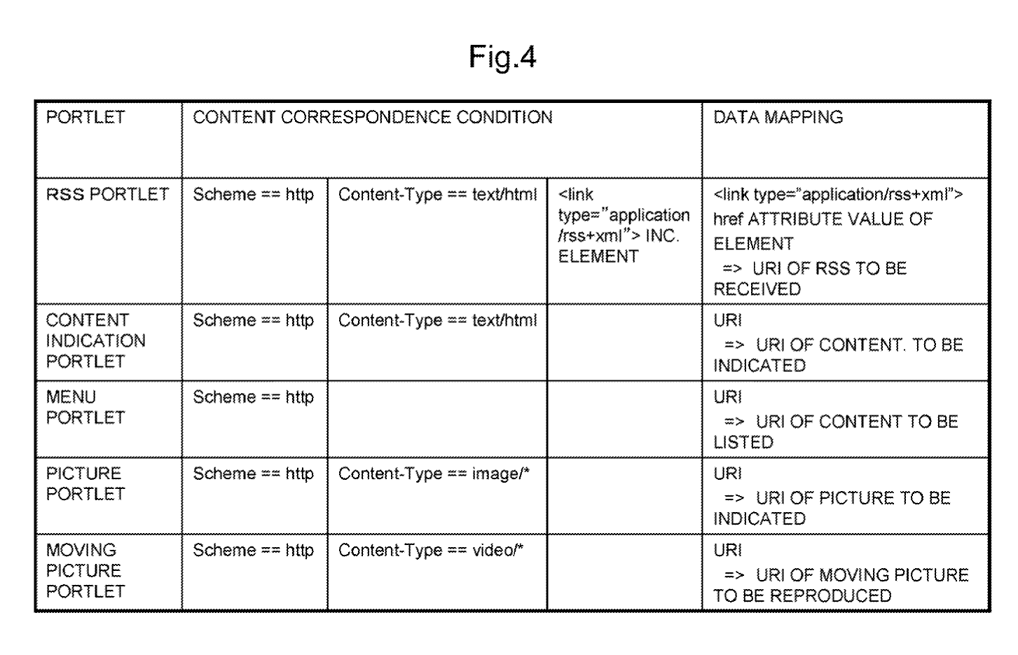

An example of such information stored in the portlet content correspondence information storage unit 104 is illustrated in FIG. 4. In FIG. 4, each row indicates portlet content correspondence information in relation to one of portlets which can be arranged on a relevant portal page.

In FIG. 4, for example, a first row indicates an example of portlet content correspondence information in relation to an RSS portlet. In this example, a content correspondence condition in relation to the RSS portlet is such that “the scheme of URI is to be based on http”, “the type of content is to be based on html” and “a link element to RSS content is to be included in the content of content information”. Further, the content of data mapping information in relation to the RSS portlet is such that “the link destination of a link element linked to RSS content is to be mapped to the URI of an RSS for reception included in the relevant RSS portlet.

Moreover, for example, a third row indicates an example of portlet content correspondence information in relation to a menu portlet. In this example, a portlet content correspondence condition in relation to the menu portlet is such that “the scheme of URI is to be based on http”, and “the type of a content is to be based on an HTML file”. Further, the content of data mapping information in relation to the menu portlet is such that “the URI of a content satisfying the correspondence condition is to be mapped to the URI of a link to a listing indication.

Moreover, for example, a fourth row indicates an example of portlet content correspondence information in relation to a picture portlet. In this example, a portlet content correspondence condition in relation to the picture portlet is such that “the scheme of URI is to be based on http”, and “the type of a content is to be an image”. Further, the content of data mapping information in relation to the picture portlet is such that “the URI of a content satisfying the correspondence condition is to be mapped to the URI of a picture to be indicated.

The portlet recommendation unit 105 outputs recommended portlets which the portlet recommendation unit 105 recommends a user to arrange on his or her portal page. Specifically, the portlet recommendation unit 105 determines contents which satisfy a correspondence condition for a portlet, from among highly frequently browsed contents, on the basis of browsing data. Here, the highly frequently browsed contents are ones specified by the browsing data analysis unit 103. Further, the content correspondence condition for a portlet is one stored in the portlet content correspondence information storage unit 104. If a plurality of content correspondence conditions is set on a portlet, the portlet recommendation unit 105 should specify a highly frequently browsed content which satisfies all of such a plurality of portlet content correspondence conditions for a portlet.

Further, the portlet recommendation unit 105 should refer to browsing data corresponding to highly frequently browsed contents, and thereby, should determine whether each of the highly frequently browsed contents satisfies the content correspondence condition, or not. If the content correspondence condition is a condition related to a type of contents, the portlet recommendation unit 105 should acquire the type of each of the highly frequently browsed contents, and thereby, should determine whether the highly frequently browsed content satisfies the content correspondence condition, or not

Further, the portlet recommendation unit 105 determines a portlet, as a recommended portlet, in which a highly frequently browsed content, which satisfies the content correspondence condition for a portlet, has been set on the relevant portlet so as to be referred to. At this time, the portlet recommendation unit 105 refers to, for the relevant portlet, browsing data in relation to highly frequently browsed contents, and data mapping information. On the basis of these kinds of information, the portlet recommendation unit 105 should determine which data of such a highly-frequently browsed content is to be applied as which one of reference destinations of setting items for the relevant portlet.

Further, the portlet recommendation unit 105 outputs a recommended portlet on which such a highly frequently browsed content has been set so as to be referred to. For example, the portlet recommendation unit 105 may output such a recommended portlet to an apparatus for creating portal pages in accordance to a user's request.

Moreover, here, it is supposed that there exists a plurality of contents which satisfies the same kind of content correspondence conditions for a portlet, among highly frequently browsed contents which are frequently browsed by the same user. In such a case, the portlet recommendation unit 105 may output a portlet, as a recommended portlet, on which the plurality of contents corresponding to the portlet has been set as reference destinations. In addition, in this case, it is presupposed that such a portlet is a portlet on which a plurality of contents can be set as reference destinations, just like a menu portlet.

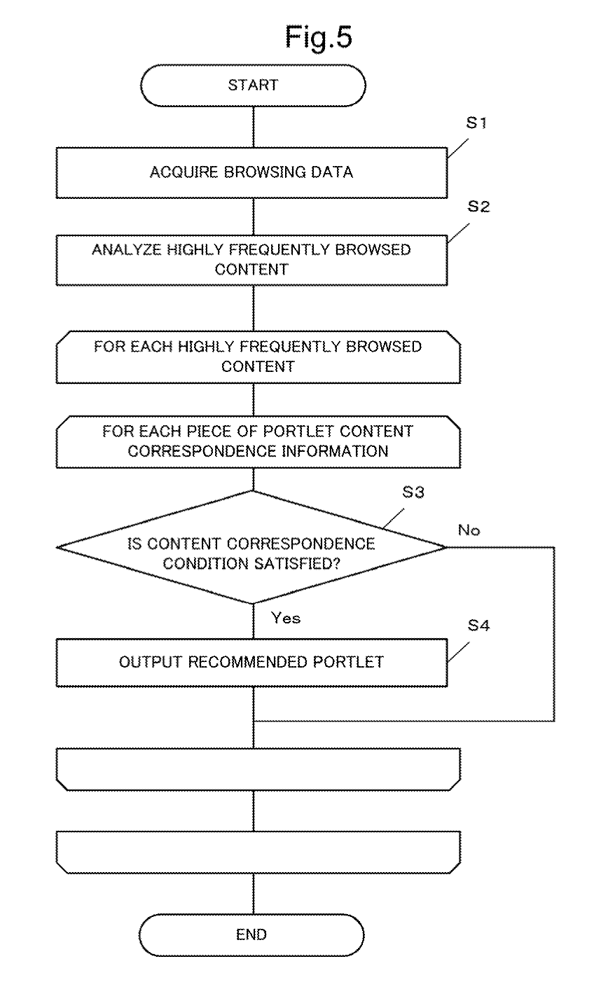

The operation of the portlet processing apparatus 1 configured in such a way as described above will be described with reference to FIG. 5.

First, the browsing data acquisition unit 101 acquires browsing data to store it into the browsing storage unit 102 (Step S1). In addition, the browsing data acquisition unit 101 may perform this operation continually in real time in conjunction with a user's content browsing operations.

Next, the browsing data analysis unit 103 specifies highly frequently browsing contents for each user on the basis of browsing data stored in the browsing data storage unit 102 (Step S2).

Next, the portlet recommendation unit 105 performs operation of the following Steps S3 to S4 for each of the highly frequently browsed contents having been specified by the browsing data analysis unit 103.

Here, for each piece of portlet content correspondence information stored in the portlet content correspondence information storage unit 104, the portlet recommendation unit 105 determines whether each of these relevant highly frequently browsed contents satisfies a content correspondence condition thereof, or not (Step S3).

For example, in the case where a condition for specifying a content type is included in this content correspondence condition for a portlet, the portlet recommendation unit 105 may determine whether the type of the relevant highly frequency browsed content corresponds to the content type specified by the content correspondence condition, or not. Further, in the case where this relevant portlet has a plurality of content correspondence conditions, the portlet recommendation unit 105 should determines whether the relevant highly frequently browsed content satisfies all the plurality of content correspondence conditions, or not.

If it is determined in Step S3 that the relevant highly frequently browsed content satisfies the content correspondence condition, the portlet recommendation unit 105 outputs information representing the relevant portlet, on which the relevant highly frequently browsed content has been set on the basis of data mapping information, as a recommended portlet (Step S4).

When the operation of Steps S3 to S4 have been completed for each of the highly frequently browsed contents which have been specified in Step S2, the portlet processing apparatus 1 terminates its operation. In addition, the portlet processing apparatus 1 may perform the operation of Steps S2 to S4 in accordance with a predetermined schedule (for example, at intervals of a predetermined period of time).

Next, advantageous effects of this first exemplary embodiment will be described.

The portlet processing apparatus as this first exemplary embodiment can recommend portlets which enable improvement of the efficiency of accesses for contents highly frequently browsed by users, without imposing any burden on users' work.

A reason of this is that the portlet processing apparatus as this first exemplary embodiment is configured in such a way as described below. First, the portlet content correspondence information storage unit stores therein, in advance, a content correspondence condition to be applied to contents which can be set as referred-to contents, for each of portlets which can be arranged on a portal page. Secondly, the portlet recommendation unit outputs portlets, in each of which, among contents highly frequently browsed by users, contents satisfying the content correspondent condition are made referred-to contents, as recommended portlets. In this way, the portlet processing apparatus as this first exemplary embodiment can recommend users to utilize portlets which are suitable for users to refer to contents highly frequently browsed by the users.

### Second Exemplary Embodiment

Next, a second exemplary embodiment will be described in detail with reference to the drawings. It is to be noted here that, in individual drawings referred to in description of this exemplary embodiment, components identical to those of the first exemplary embodiment, as well as steps in which operations are performed in ways similar to those of the steps of the first exemplary embodiment, are denoted by identical reference numerals, and detailed descriptions thereof in this exemplary embodiment are omitted.

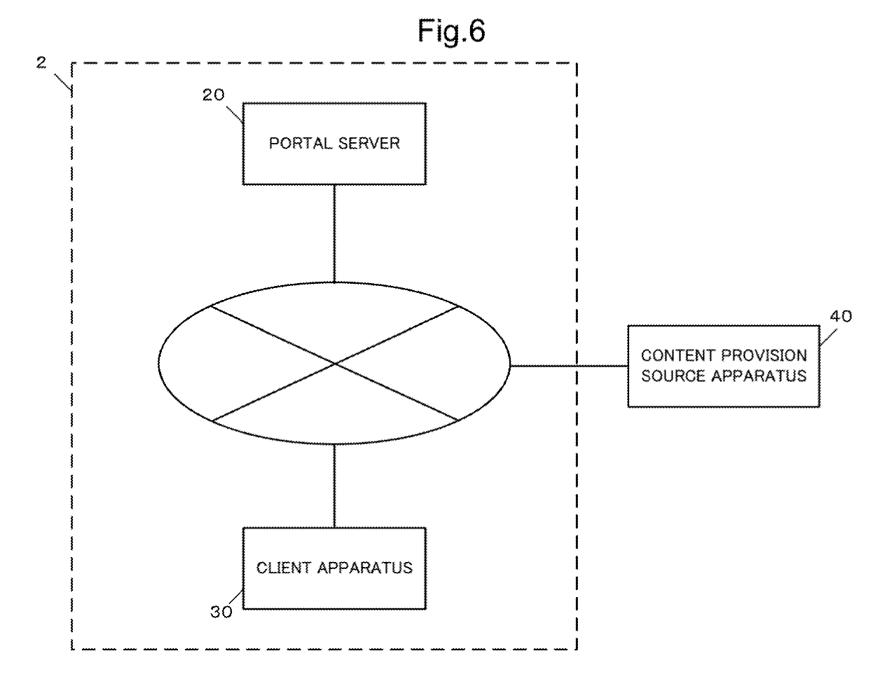

First, the configuration of a portal system 2 as a second exemplary embodiment is illustrated in FIG. 6. In FIG. 6, the portal system 2 includes a portal server 20 and a client apparatus 30. The portal server 20 and the client apparatus 30 are connected to each other via network including one or more of the Internet, a LAN (Local Area Network), a public line network and a wireless communication network. Further, the client apparatus 30 is configured to be able to communicate with a content provision source apparatus 40 for providing contents, via such network. In addition, although, in FIG. 6, there is illustrated one apparatus for each of the portal server 20, the client apparatus 30 and the content provision source apparatus 40, this does not limit the number of each type of apparatuses included in a portal system, as well as the number of content provision source apparatus to which the portal system is connected.

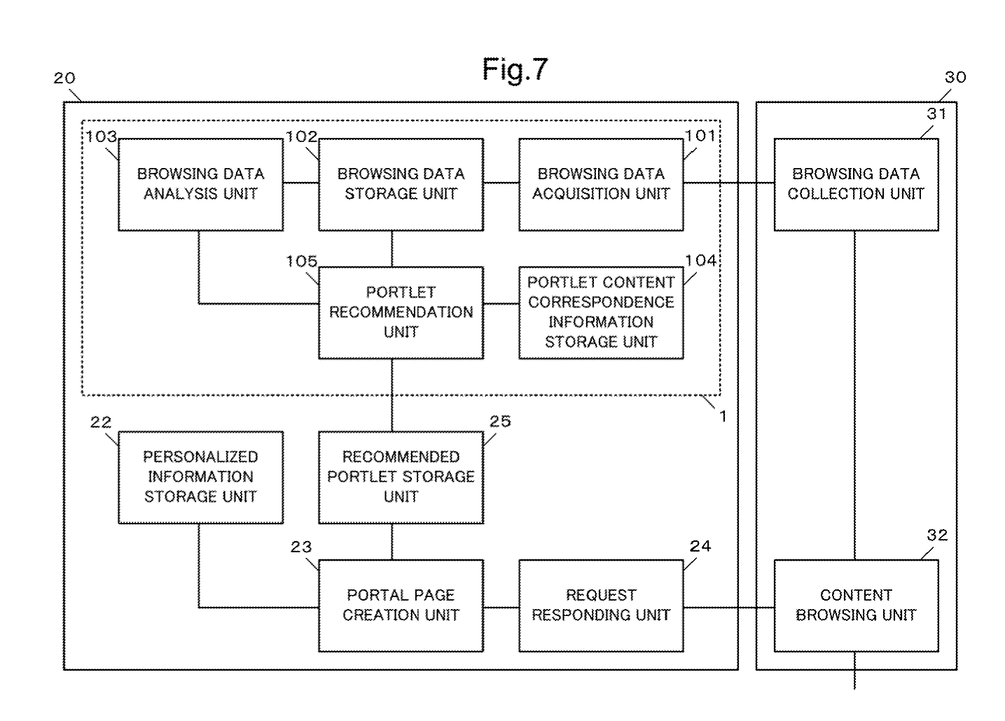

Next, a configuration of function blocks of the portal system 2 is illustrated in FIG. 7. In FIG. 7, the portal server 20 includes the portlet processing apparatus 1 as the first exemplary embodiment, a personalized information storage unit 22, a portal page creation unit 23, a request responding unit 24 and a recommended portlet storage unit 25.

The recommended portlet storage unit 25 stores therein, for each user, information representing recommended portlets outputted by the portlet recommendation unit 105. For example, the recommended portlet storage unit 25 stores therein the pieces information representing corresponding recommended portlets so as to correlate the pieces of information with user IDs for identifying corresponding users.

The personalized information storage unit 22 stores therein personalized information representing portlets which are arranged on portal pages of respective users. The personalized information includes information which, for each user, represents a list of portlets which have been already arranged on a portal page, reference destinations of contents, which are set on each of the portlets, location relations among the individual portlets and the like. For example, the personalized information storage unit 22 stores therein the personalized information so as to correlate the personalized information with the above-described user IDs.

The portal page creation unit 23 creates portal pages for respective users. First, the portal page creation unit 23 acquires a user ID which is included in a request acquired by the request responding unit 24 described below. Further, the portal page creation unit 23 acquires recommended portlets correlated with such a user ID from the recommended portlet storage unit 25. Moreover, the portal page creation unit 23 acquires personalized information correlated with such a user ID from the personalized information storage unit 22. Further, the portal page creation unit 23 creates a portal page on the basis of the personalized information and the recommended portlets.

For example, the portal page creation unit 23 may create a portal page so as to, first, arrange portlets indicated by the personalized information on the portal page, and secondly, temporarily arrange the recommended portlets in unused areas within the portal page. Further, the portal page creation unit 23 may add information for explaining the recommendation of such a recommended portlet within an area, or around an area, where the recommended portlet has been temporarily arranged.

In response to a request for creation of a portal page from the client apparatus 30, the request responding unit 24 requests the portal page creation unit 23 to create a portal page therefor. Further, the request responding unit 24 sends a portal page having been created by the portal page creation unit 23 to the client apparatus 30 which is a request source. For example, the request responding unit 24 may be realized by a web server application which provides the client apparatus 30 with contents in accordance with communication based on HTTP.

Further, as shown in FIG. 7, the client apparatus 30 includes a browsing data collection unit 31 and a content browsing unit 32.

The content browsing unit 32 sends a request to a content provision source, acquires contents therefrom, and outputs the contents to a display apparatus or the like. Further, the content browsing unit 32 sends a request for a portal page to a portal server 20, acquires a portal page therefrom, and outputs the portal page to a display apparatus or the like. For example, the content browsing unit 32 may be realized by a web browser application which acquires contents from a content provision source in accordance with communication based on HTTP.

The browsing data collection unit 31 collects a history of browsing of contents taken by the content browsing unit 32 as browsing data for a relevant user, and sends it to the portal server 20. Further, the browsing data collection unit 31 sends such browsing data to the portal server 20 together with a user ID of a user who utilizes the client apparatus 30. The browsing data collection unit 31 should apply, as such a user ID, a user ID having been acquired in advance to customize a portal page.

For example, when the content browsing unit 32 performs HTTP communication, the browsing data collection unit 31 may collect browsing data each piece thereof including a user ID, the URI of an acquired content, the type of an acquired content (a content type in a HTTP response header) and the content of acquired content information.

The operation of the portal system 2 configured in such a way as described above will be described with reference to the drawings. Here, the operation of the portal system 2 will be described by dividing the operation of the portal system 2 into three stages: a browsing data recording operation, a recommended portlet determination operation and a recommended portlet presentation operation.

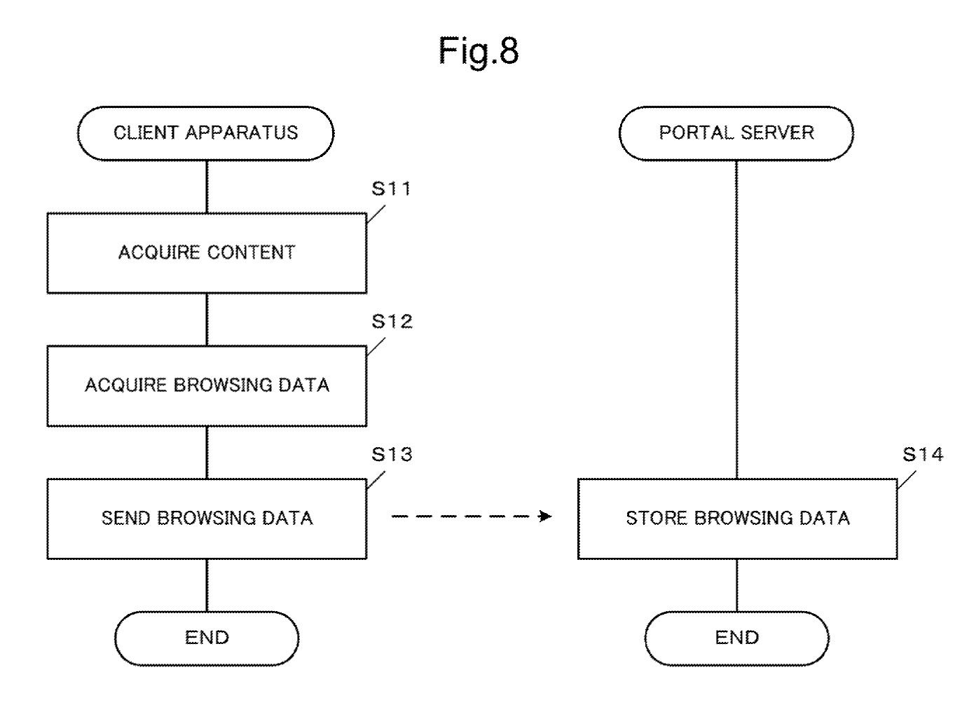

First, the browsing data recording operation is illustrated in FIG. 8. In FIG. 8, a left figure illustrates the operation of the client apparatus 30, a right figure illustrates the operation of the portal server 20, and a dotted arrow connecting the left figure and the right figure denotes a data flow between the apparatuses.

In FIG. 8, first, the content browsing unit 32 of the client apparatus 30 acquires contents from the content provision source apparatus 40 and displays them on a display apparatus on a user operation basis. (Step S11).

Next, the browsing data collection unit 31 acquires browsing data representing a history of browsing of contents having been displayed in Step S11 (Step S12). As described above, the browsing data may be also data including user IDs, URIs, content types and the contents of content information.

Next, the browsing data collection unit 31 sends the browsing data having been acquired in Step S12 to the portal server 20 (Step S13). In addition, the browsing data collection unit 31 may temporarily store and accumulate the browsing data having been acquired in Step S12, and may send the accumulated browsing data to the portal server 20 at each predetermined timing point.

Next, the browsing storage unit 102 of the portal server 20 stores therein the browsing data having been received in Step S13 (Step S14).

Along with the completion of the processing described above, the portal system 2 terminates the browsing data recording operation.

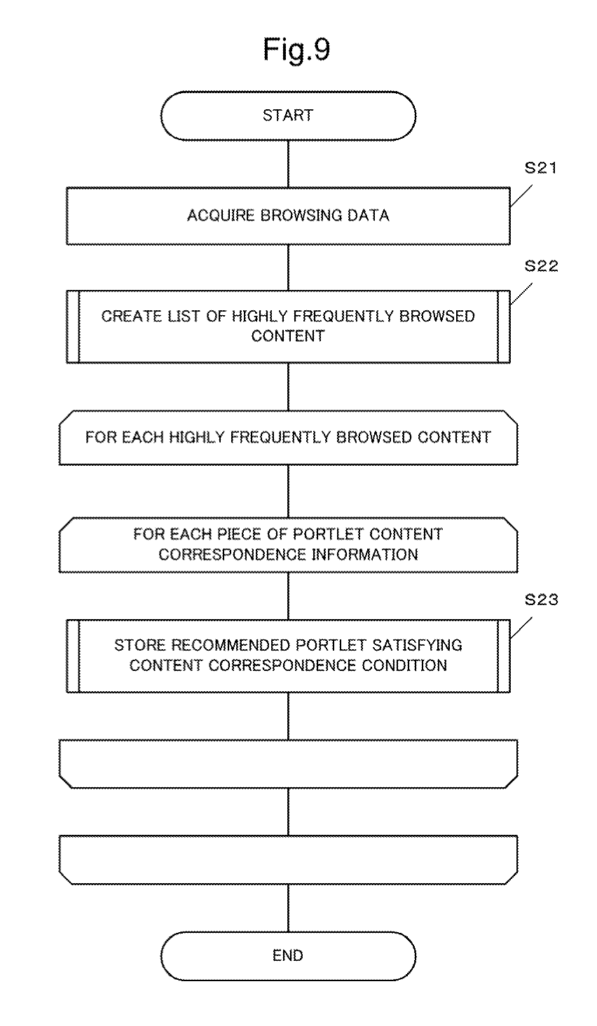

Next, the recommended portlet determination operation of the portal system 2 is illustrated in FIG. 9.

In FIG. 9, first, the browsing data analysis unit 103 of the portal server 20 acquires browsing data from the browsing data storage unit 102 (Step S21).

Next, the browsing data analysis unit 103 creates a list of data representing contents highly frequently browsed by a user (i.e., a list of highly frequently browsed contents) from the browsing data having been acquired in Step S21 (Step S22). Such a list of highly frequently browsed contents may be a list of data including user IDs, URIs, content types and the contents of content information, just like in the case of the browsing data. The operation of this step will be described below in detail.

Next, the portlet recommendation unit 105 performs operation of the following Step S23, for individual combinations of pieces of portlet content correspondence information stored in the portlet content correspondence information storage unit 104 and highly frequently browsed contents included in the list of highly frequently browsed contents having been created in Step S22.

Here, if this relevant highly frequently browsed content satisfies a relevant content correspondence condition included in the portlet content correspondence information, the portlet recommendation unit 105 stores, as a recommended portlet, a portlet corresponding to a user who has frequently browsed the relevant highly frequently browsed content into the recommended portlet storage unit 25 (Step S23). The operation of this step will be described below in detail.

When the processing of Step S23 has been completed for the individual combinations of the pieces of portlet content correspondence information and the highly frequently browsed contents, the portal system 2 terminates the recommended portlet determination operation. In addition, the portal server 20 may carry out the recommended portlet determination operation for each predetermined timing point.

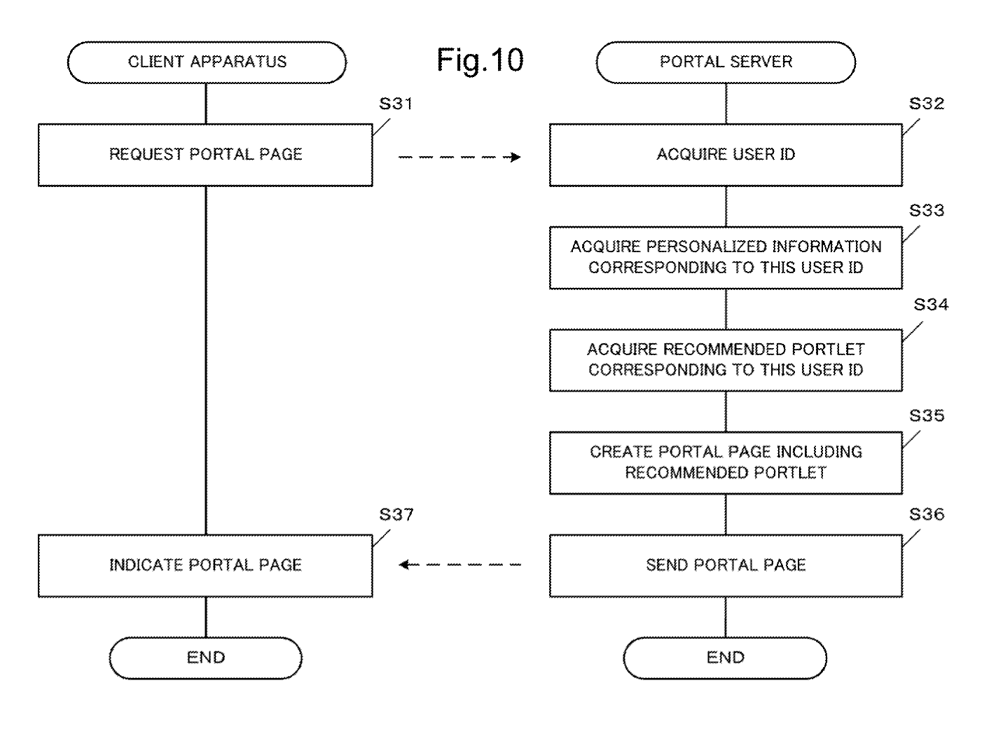

Next, the recommended portlet presentation operation of the portal system 2 is illustrated in FIG. 10. In FIG. 10, a left figure indicates the operation of the client apparatus 30, a right figure indicates the operation of the portal server 20, and a dotted arrow connecting the left figure and the right figure denotes a data flow between the apparatuses.

In FIG. 10, first, the content browsing unit 32 of the client apparatus 30 sends a request for a portal page to the portal server 20 (Step S31).

Next, the request responding unit 24 of the portal server 20 transfers the received request to the portal page creation unit 23. Further, the portal page creation unit 23 acquires a user ID included in the request (Step S32).

Next, the portal page creation unit 23 acquires personalized information corresponding to the relevant user ID from the personalized information storage unit 22 (Step S33).

Next, the portal page creation unit 23 acquires recommended portlets corresponding to the relevant user ID from the recommended portlet storage unit 25 (Step S34). In addition, any one of the operations of Steps S33 and S34 can be performed in advance of the other one.

Next, the portal page creation unit 23 creates a portal page on the basis of the personalized information and the recommended portlets corresponding to the relevant user ID (Step S35).

Next, the request responding unit 24 sends the portal page having been created in Step S35 to the client apparatus 30 as a response (Step S36).

Next, the content browsing unit 32 of the client apparatus 30 outputs the received portal page to a display apparatus (Step S37).

Along with the completion of the processing described above, the portal system 2 terminates the recommended portlet presentation operation.

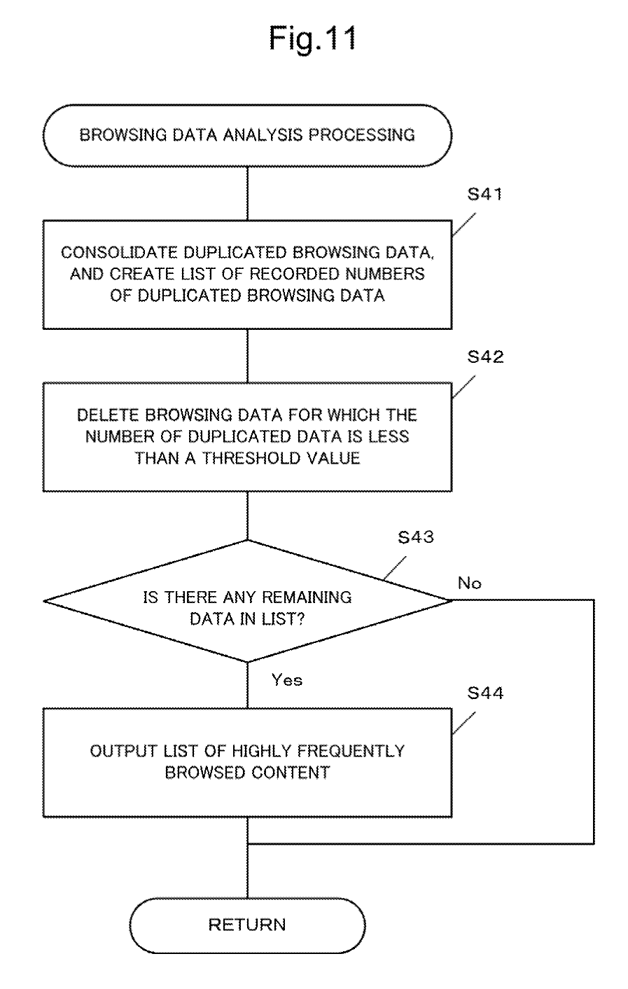

Next, the details of the browsing data analysis processing in Step S22 shown in FIG. 9 will be described with reference to FIG. 11.

In FIG. 11, first, the browsing data analysis unit 103 consolidates duplicated pieces of data among the browsing data having been acquired from the browsing storage unit 102, and creates a list of data in which the number of the duplicated pieces of browsing data is recorded (Step S41).

Here, the duplicated pieces of browsing data mean a plurality of browsing data which satisfies a predetermined condition indicating that each browsing is to be a browsing of the same content, performed by the same user. Such a predetermined condition may be a condition indicating that, for example, all of the user IDs, the URIs and the content types are the same.

Further, consolidating duplicated pieces of browsing data means creating one piece of data from such a plurality pieces of duplicated data. For example, such a resultant piece of data may include a user ID, a URI, a content type, the content of content information and the number of duplicated pieces of data. At this time, if there are pieces of browsing data having the same user ID, the same URI, the same content type and mutually different contents of content information, the browsing data analysis unit 103 may allow the content of content information of any one of the pieces of browsing data (for example, the content of content information of the latest piece of browsing data) to be included in a piece of browsing data resulting from consolidating the pieces of browsing data.

Next, the browsing data analysis unit 103 excludes data for which the number of duplicated pieces of data in the created list is less than a threshold value (Step S42).

Next, the browsing data analysis unit 103 determines whether one or more pieces of data remain in the list, or not (Step S43).

Here, if no piece of data remains in the list, the browsing data analysis unit 103 terminates the operation.

In contrast, if one or more pieces of data remain in the list, the browsing data analysis unit 103 outputs this list as a list of highly frequently browsed contents (Step S44).

Along with the completion of the processing described above, the browsing data analysis unit 103 terminates the browsing data analysis processing.

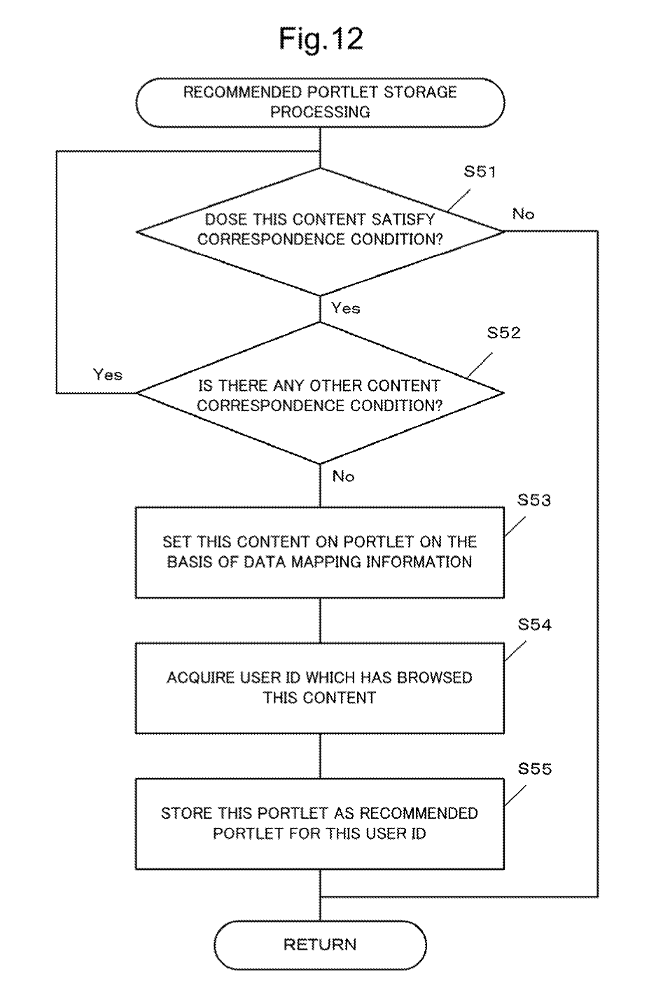

Next, the details of operation of the recommended portlet storage processing in Step S23 shown in FIG. 9 will be described with reference to FIG. 12. This processing is carried out for all of individual combinations of pieces of portlet content correspondence information stored in the portlet content correspondence information storage unit 104 and highly frequently browsed contents included in the list of highly frequently browsed contents.

In FIG. 12, first, the portlet recommendation unit 105 determines whether this relevant highly frequently browsed content satisfies any one of content correspondence conditions of this portlet content correspondence information, or not (Step S51).

Here, if the relevant highly frequently browsed content does not satisfy any one of the content correspondence conditions, the portlet recommendation unit 105 determines that the relevant highly frequently browsed content cannot be handled in this relevant portlet. Further, the portlet recommendation unit 105 terminates the processing for the combination of the relevant portlet content correspondence information and the relevant highly frequently browsed content

In contrast, if the relevant highly frequently browsed content satisfies any one of the relevant content correspondence conditions, the portlet recommendation unit 105 determines whether the relevant portlet content correspondence information includes any other content correspondence condition having not been subjected to the processing, or not (Step S52). Here, this other content correspondence condition having not been subjected to the processing means a content correspondence condition for which a determination as to whether the relevant highly frequently browsed content satisfies the content correspondence condition is not yet made.

Here, if the relevant portlet content correspondence information includes any other content correspondence condition having not been subjected to the processing, the portlet recommendation unit 105 repeats the operations of Step S51 and subsequent Steps.

In contrast, if the relevant portlet content correspondence information includes no content correspondence condition having not been subjected to the processing, the portlet recommendation unit 105 refers to data mapping information of the relevant portlet content correspondence information, and thereby, determines which piece of data of those of the relevant highly frequently browsed content is to be applied to which setting item of those of the relevant portlet (Step S53).

Next, in the list of highly frequently browsed contents, the portlet recommendation unit 105 acquires a user ID correlated with the relevant content (Step S54).

Next, the portlet recommendation unit 105 correlates a recommended portlet representing the relevant portlet to which the setting item having been determined in Step S53 is applied, with the user ID having been acquired in Step S54, and stores the resultant recommended portlet into the recommended portlet storage unit 25 (Step S55).

Along with the completion of processing described above, the portlet recommendation unit 105 terminates the recommended portlet storage operation.

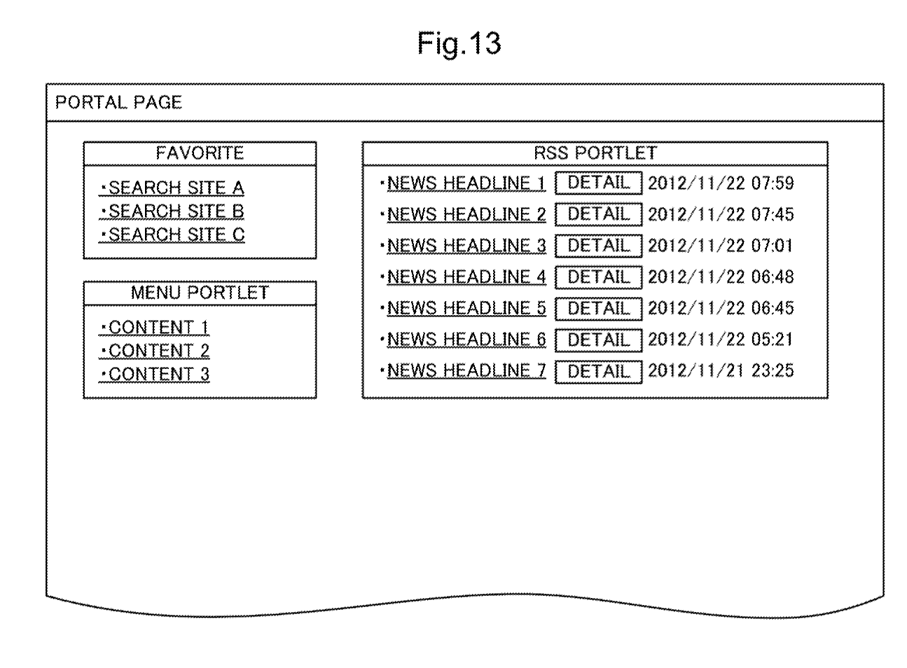

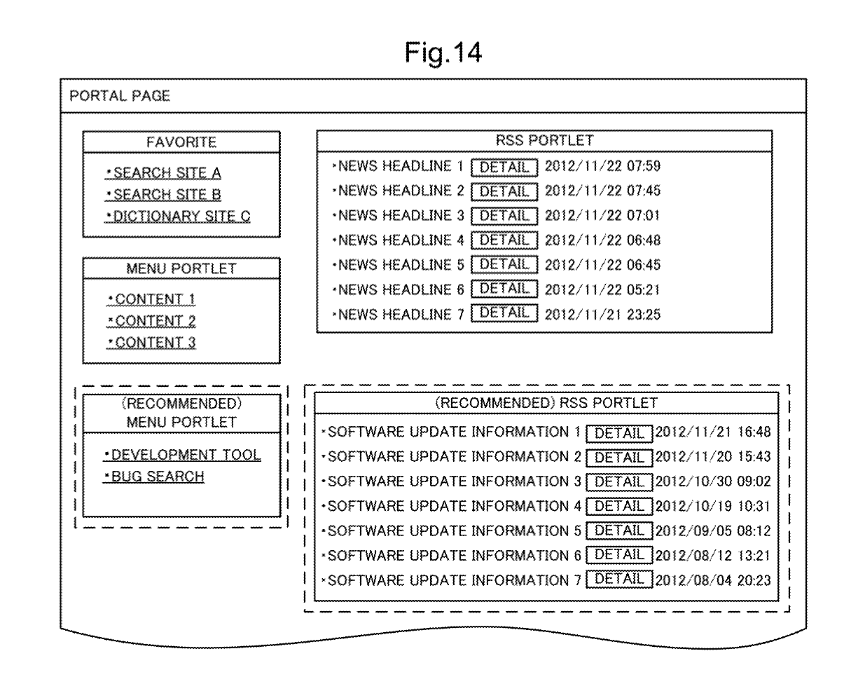

In the portal system 2 configured to operate in such a way as described above, it is assumed that a certain user utilizes a portal page having been customized such as shown in FIG. 13. Further, it is assumed that, outside the portal page, this user frequently refers to a website which delivers contents whose titles are “development tool” and “bug searching”, and RSS feed in relation to software updating information. Under such an assumption, the portal system 2 provides a portal page, to which a recommended portlet shown in FIG. 14 is added, by performing operation shown in FIGS. 8 to 12. In FIG. 14, at a lower left position, a menu portlet, which indicates a list of links to contents, such as a “development tool” and “bug searching”, is arranged as a recommended portlet. Further, at a lower right position, an RSS portlet, which indicates the latest information in relation to software updating, is arranged as a recommended portlet.

Next, advantageous effects of this second exemplary embodiment will be described.

The portal system as this second exemplary embodiment can provide users with portal pages, each of which is customized so as to improve the efficiency of accesses for contents which are highly frequently browsed by users, without imposing any burden on users' work.

A reason of this is that the portal system as this exemplary embodiment is configured in such a way as descried below. First, the portlet recommendation apparatus determines recommended portlets on the basis of a history of browsing of contents other than those on a portal page of a user. Secondly, the portal page creation unit creates portal pages on which recommended portlets for each user are arranged. In this way, as a result, each user can utilize a portal page on which various portlets, each providing a gateway to frequently browsed contents, are automatically arranged. Consequently, the portal system as this exemplary embodiment enables reduction of user cost on customization of portal pages, as well as user cost on leaning of operation methods for customizing portals, the types of portlets, usage methods of portlets and the like.

### Third Exemplary Embodiment

Next, a third exemplary embodiment will be described in detail with reference to the drawings. It is to be noted here that, in individual drawings referred to in description of this exemplary embodiment, components identical to those of the first and second exemplary embodiments, as well as steps in which operations are performed in ways similar to those of the steps of the first and second exemplary embodiment, are denoted by identical reference numerals, and detailed description thereof in this exemplary embodiment is omitted.

In this exemplary embodiment, an example, in which a portal system is applied to a group portal-page development work supporting system, will be described. Such a group portal-page development work supporting system accumulates browsing data for users belonging to a group which is assumed to use a portal system in the future, before starting the operation of the portal system. Further, such a group portal-page development work supporting system supports work for developing a model of a portal page for a group on the basis of browsing data having been accumulated.

In this exemplary embodiment, it is supposed that a group ID for identifying a group, which is an aggregation of users, is applied as a user ID. That is, it is supposed that a browsing data collection unit 31 of the client apparatus 30 used by users belonging to target group stores a group ID in advance, and sends browsing data including the group ID to a portal server 50.

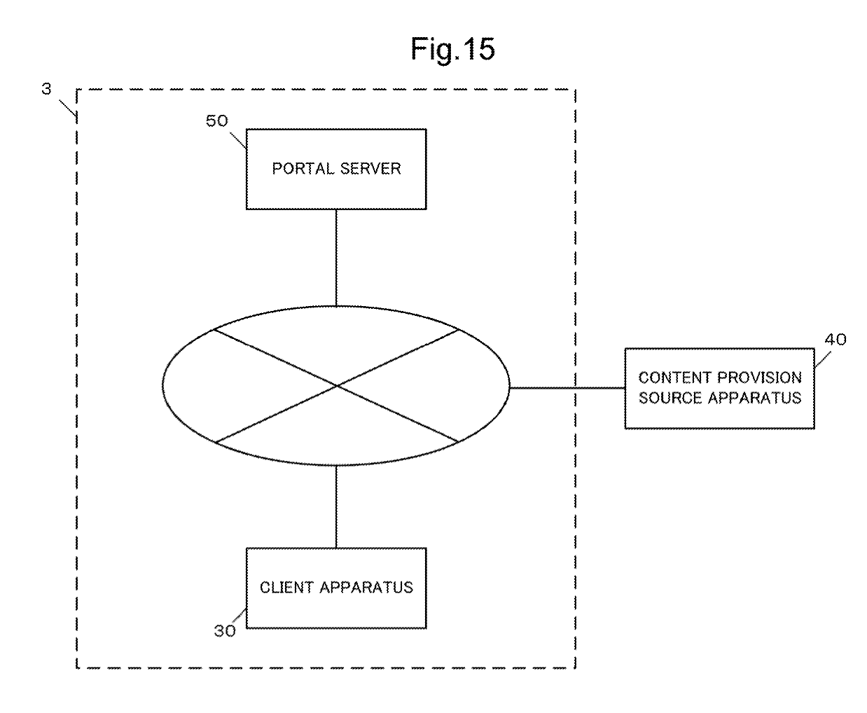

First, the configuration of a group portal-page development work supporting system 3 as a third exemplary embodiment is illustrated in FIG. 15. In FIG. 15, the group portal-page development work supporting system 3 is different from the portal system 2 as the second exemplary embodiment in respect that a portal server 50 is provided as substitute for the portal server 20. In addition, although, in FIG. 15, there is illustrated one apparatus for each type of apparatuses, this does not limit the number of each type of apparatuses included in a portal system, as well as the number of content provision source apparatus to which the portal system is connected.

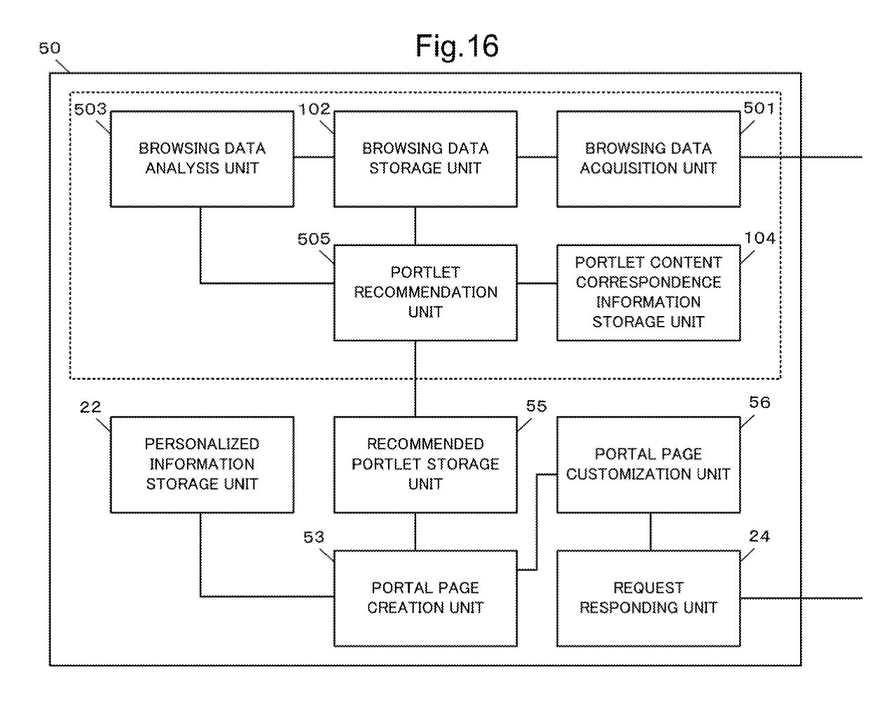

Next, the configuration of function blocks of the portal server 50 is illustrated in FIG. 16. The portal server 50 is different from the portal server 20 as the second exemplary embodiment in respect that a browsing data acquisition unit 501 is substituted for the browsing data acquisition unit 101, a browsing data analysis unit 503 is substituted for the browsing data analysis unit 103, a portlet recommendation unit 505 is substituted for the portlet recommendation unit 105, a portlet creation unit 53 is substituted for the portlet creation unit 23, and a recommended portlet 55 is substituted for the recommended portlet 25. Further, the portal server 50 is different from the portal server 20 as the second exemplary embodiment in respect that a portal page customization unit 56 is further provided.

The browsing data acquisition unit 501 is different from the browsing data acquisition unit 101 in the first and second exemplary embodiments in respect that browsing data related to a target group is acquired in advance. For example, the browsing data acquisition unit 501 may extract browsing data including a target group ID, from among browsing data having been received from the client apparatus 30 during a predetermined period of time, and may accumulate the browsing data in the browsing data storage unit 102.

The browsing data analysis unit 503 specifies highly frequently browsed contents which are frequently browsed by users belonging to a target group, on the basis of browsing data stored in the browsing data storage unit 102. For example, the browsing data analysis unit 503 may specify contents, for each of which the number of browsing data having the same group ID is no smaller than a threshold value, as highly frequently browsed contents of the group.

Further, for each of the specified highly frequently browsed contents, the browsing data analysis unit 503 calculates a browsing frequency representing the frequency of browsing having been performed for the specified highly frequently browsed content during a predetermined period of time, and outputs the calculated browsing frequency together with the specified highly frequently browsed content. Specifically, the browsing data analysis unit 503 calculates, as a browsing frequency, the number of pieces of browsing data which have the same group ID, the same URI and the same content type among the browsing data stored in browsing data storage unit 102. Further, the browsing data analysis unit 503 correlates the calculated browsing frequency with a corresponding set of the group ID, the URI, the content type and the content of content information, and creates sets of the group ID, the URI, the content type and the content of content information, each being correlated with a browsing frequency no smaller than a threshold value, as a list of highly frequently browsed contents.

The portlet recommendation unit 505 calculates, for each of acquired recommended portlets, a degree of recommendation representing the degree of recommending the acquired recommended portlet, just like the portlet recommendation unit 105 of the first and second exemplary embodiments. Further, the portlet recommendation unit 505 correlates the degree of recommendation with the recommended portlet, and stores the resultant recommended portlet into the recommended portlet storage unit 55.

In other words, the portlet recommendation unit 505 outputs the degree of recommendation together with the recommended portlet.

Specifically, the portlet recommendation unit 505 calculates the degree of recommendation on the basis of the browsing frequency of a highly frequently browsed content, which has been set as a reference destination of the recommended portlet. For example, the portlet recommendation unit 505 may handle the browsing frequency as the degree of recommendation as it is. In the case where, for one recommended portlet, a plurality of highly frequently browsed contents are set as reference destinations, the portlet recommendation unit 505 may calculate one degree of recommendation on the basis of the respective browsing frequencies of such a plurality of highly frequently browsed contents. For example, the portlet recommendation unit 505 may handle a maximum value of the plurality of browsing frequencies as the degree of recommendation for the recommended portlet.

The recommended portlet storage unit 55 stores therein information representing the recommended portlet so as to correlate the information with a group ID. Moreover, the recommended portlet storage unit 55 stores therein the recommended portlets so as to correlate each of the recommended portlets with corresponding information representing the degree of recommendation.

The portal page creation unit 53 arranges each recommended portlet on a portal page created in a way similar to that of the portal page creation unit 23 in the second exemplary embodiment, on the basis of the degree of recommendation of the recommended portlet. For example, the portal page creation unit 53 may determine the location area of each of the recommended portlets on the basis of the degree of recommendation of the recommended portlet. Specifically, the portal page creation unit 53 may locate the recommended portlets such that a recommended portlet having a larger degree of recommendation is located at the upper portion of a portal page. Additionally, for recommended portlets each having the degree of recommendation which is no less than a threshold value, the portal page creation unit 53 may arrange such recommended portlets together with additional information which represents that the degree of recommendation is high.

In addition, in the case where any information correlated with this relevant group ID is not yet stored in the personalized information storage unit 22, the portal page creation unit 53 should arrange recommended portlets on a portal page on which any portlet is not arranged, on the basis of their degrees of recommendation.

The portal page customization unit 56 receives information in relation to customization of recommended portlets arranged on a portal page, from the client apparatus 30. For example, the portal page customization unit 56 may receive information representing the change of positions where recommended portlets are located, from the client apparatus 30. Further, the portal page customization unit 56 may receive information for notifying a determination to instruct recommended portlets temporarily arranged on a portal page to be formally arranged, or information for notifying a determination to instruct recommended portlets temporarily arranged on a portal page not to be arranged, from the client apparatus 30. Moreover, the portal page customization unit 56 may also receive information in relation to the location change of portlets other than the recommended portlets, and information in relation to customization, such as addition or deletion, from the client apparatus 30 in addition to such information as described above.

Further, the portal page customization unit 56 notifies the portal page creation unit 53 to update the portlets on a portal page based on received information in relation to the customization of portlets including such recommended portlets. Further, the portal page customization part 56 updates the personalized information storage unit 22 on the basis of received information in relation to customization.

The operation of the group portal-page development work supporting system 3 configured in such a way as described way will be described with reference to the drawings.

The browsing data recording operation of the group portal-page development work supporting system 3 is similarly described by substituting the group ID for the user ID in the browsing data recording operation of the second exemplary embodiment having been described using FIG. 8. In this regard, in this exemplary embodiment, the group portal-page development work supporting system 3 performs such browsing data recording operation in advance.

The recommended portlet determination operation of the group portal-page development work supporting system 3 is similarly described by substituting the group ID for the user ID in the recommended portlet determination operation of the second exemplary embodiment having been described using FIG. 9 In this regard, in the detailed description (FIG. 11) of the browsing data analysis processing in Step S22, there is a difference in that the number of duplication of data is included in the list of highly frequently browsed contents as a browsing frequency. Further, in the detailed description (FIG. 12) of the recommended portlet storage processing in Step S23, there is a difference in that the degree of recommendation based on the browsing frequency is stored in the recommended portlet storage unit 55 together with the recommended portlet.

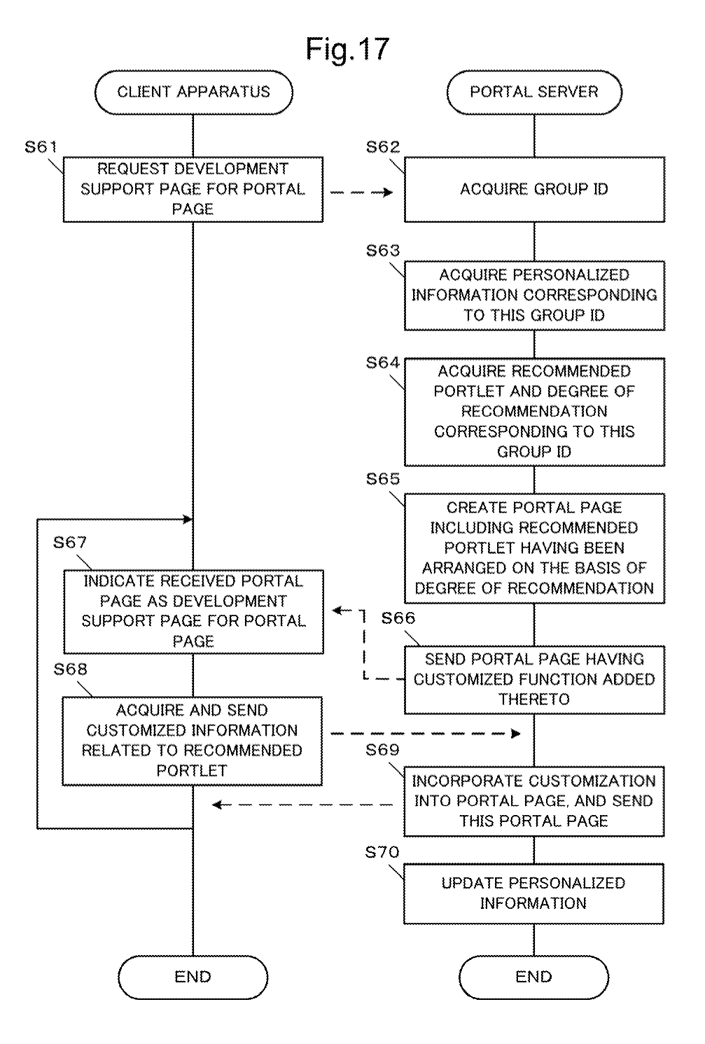

Next, the recommended portlet presentation operation of the group portal-page development work supporting system 3 will be described with reference to FIG. 17. In FIG. 17, a left figure indicates the operation of the client apparatus 30 operated by a portal page creator, a right figure indicates the operation of the portal server 50, and a dotted arrow connecting the left figure and the right figure denotes a data flow between the apparatuses.

In FIG. 17, first, the content browsing unit 32 of the client apparatus 30 sends a request for a development support page for a portal page to the portal server 50 (Step S61). This request includes a group ID.

Next, the request responding unit 24 of the portal server 50 transfers the received request to the portal page creation unit 53. Further, the portal page creation unit 53 acquires the group ID included in the request (Step S62).

Next, if any personalized information corresponding to the group ID is stored in the personalized information storage unit 22, the portal page creation unit 53 acquires this personalized information (Step S63). In addition, when a portal page for a group is developed for the first time, such personalized information is not yet stored in the personalized information storage unit 22. In this case, the personalized information does not need to be acquired in this step.

Next, the portal page creation unit 53 acquires a recommended portlet and its degree of recommendation corresponding to the relevant group ID from the recommended portlet storage unit 55 (Step S64). In addition, any one of the operations of Steps S63 and S64 can be performed in advance of the other one.

Next, the portal page creation unit 53 creates a portal page including portlets based on the personalized information having been acquired in Step S63, and recommended portlets, which has been acquired in Step S64 (Step S65). In addition, the portlets and the recommended portlets are located on a portion of the portal page on the basis of their degrees of recommendation.

If any personalized information has not been acquired in Step S63, in Step S65, the portal page creation unit 53 should arrange the recommended portlets on a portion of the portal page, where any portlet is not yet allocated, on the basis of their degrees of recommendation. Further, as described above, the portal page creation unit 53 may arrange the recommended portlets such that a recommended portlet having a larger degree of recommendation is located at the upper portion of a portal page. In this way, portlets which are assumed to be highly frequently utilized are located at positions attracting users' attentions.

Next, the request responding unit 24 sends the portal page having been created in Step S65 to the client apparatus 30 as a response (Step S66).

Next, the content browsing unit 32 of the client apparatus 30 indicates the received portal page as a development support page (Step S67).

Next, the content browsing unit 32 acquires information in relation to various customizations, such as information indicating location changes of recommended portlets, information indicating setting changes of recommended portlets and information indicating location determinations or deletions of recommended ports, via an input apparatus. Further, the content browsing unit 32 sends the information in relation to customizations to the portal server 50 (Step S68).

Next, the portal page customization part 56 of the portal server 50 transfers the received information in relation to customizations to the portal page creation unit 53. Further, the portal page customization unit 56 sends the portal page having the customizations incorporated therein to the client apparatus 30 as a response (Step S69).

In the client apparatus 30, the operations of Steps S67 to S68 are carried out repeatedly until the browsing of the development support page has been completed.

Next, the portal page customization part 56 of the portal server 50 correlates personalized information based on the information in relation to the customizations, having been received in Step S68, with a corresponding group ID, and stores the resultant personalized information into the personalized information storage unit 22 (Step S70).

Along with the completion of the processing described above, the group portal-page development work supporting system 3 terminates the recommended portlet presentation operation. In this way, the group portal-page development work supporting system 3 can support work for creating a model of a portal page for a given group.

Next, advantageous effects of this third exemplary embodiment will be described.

The group portal-page development work supporting system as the third exemplary embodiment can support such that a portal page for a group, which has been customized so as to improve the efficiency of accesses for contents highly frequently browsed by users belonging to the group, can be developed easily.

A reason of this is that the group portal-page development work supporting system as this exemplary embodiment has been configured in such a way as described below. First, the browsing data acquisition unit accumulates the browsing data of users belonging to a relevant group in advance. Secondly, the portlet recommendation unit determines and presents recommended portlets on the basis of portlet content correspondence information and browsing data inside the relevant group. Thirdly, the portlet recommendation unit calculates the degree of recommendation of a recommended portlet on the basis of the browsing frequencies of respective contents which are reference destinations of the recommended portlet. Fourthly, the portal page creation unit arranges the recommended portlets on the basis of their degrees of recommendation. Fifthly, the portal page customization unit receives customizations for the recommended portlets, and updates personalized information for the relevant group. In this way, a user who attempts to develop a portal page for a relevant group can easily arrange portlets each being suitable for a gateway to contents highly frequently browsed by users of the group without any particular knowledge.

In addition, the third exemplary embodiment is also applicable as, not only a system for supporting group portal-page developing work, but also a portal system for providing individual users with customization functions for a portal page.

In each of the exemplary embodiments, it has been described that the browsing data acquisition unit of the portal server excludes the history of browsing of portal pages of browsing data. Besides, the browsing data collection unit of the client apparatus may send browsing data, resulting from excluding the history of browsing of portal pages, to a portal server. Alternatively, the browsing data analysis unit may perform analyzing processing after having excluded the history of browsing of portal pages of browsing data stored in the browsing data storage unit.

In each of the exemplary embodiments, although it has been described that information representing the content of each piece of content information is stored in the browsing data storage unit, the browsing data storage unit as each exemplary embodiment may not need to store all the information representing the content of each piece of content information. For example, the browsing data storage unit may memorize elements of the individual contents of content information in advance, which may be referred to when the confirmation of correspondence with portlet content correspondence conditions for respective portlets is performed, or may be referred to as reference destinations of respective portlets when the confirmation of correspondences with the data mapping information is performed, and may extract portions including such elements to store them therein.

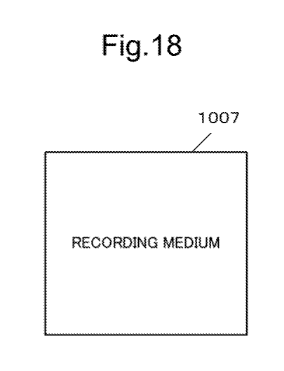

In each of the exemplary embodiments described above, the operation of the portlet processing apparatus having been described with reference to the flowchart is stored in a storage device (a storage medium or a recording medium) of a computer apparatus as a computer program according to the present invention, and the CPU may read the computer program to execute it. Further, in such a case, the present invention is configured by the codes of the computer program or the storage medium storing the computer program therein. FIG. 18 is a block diagram illustrating the configuration of a recording medium (a storage medium) 1007. The recording medium 1007 may be a nonvolatile recording medium.

Further, the individual exemplary embodiments described above can be carried out by being appropriately combined with one another.

Further, the present invention is not limited to the individual exemplary embodiments described above, but can be carried out in various forms.

A portal server according to another aspect of the present invention includes: the aforementioned portlet processing apparatus; a recommended portlet storage unit that stores therein the recommended portlet of the user, which is outputted by the portlet processing apparatus; a personalized information storage unit that stores therein personalized information representing the portlet arranged on the portal page of the user; a portal page creation unit that creates the portal page of the user on the basis of the recommended portlet stored in the recommended portlet storage unit, and the personalized information stored in the personalized information storage unit; and a request responding unit that, in response to a request from a client apparatus, sends the portal page having been created by the portal page creation unit.

A portal system according to another aspect of the present invention is a portal system including the aforementioned portal server and the aforementioned client apparatus, wherein the client apparatus includes a content browsing unit that acquires and outputs the content from a content provision source of the content, and acquires the portal page by sending the request for the portal page to the portal server and outputs the acquired said content, and a browsing data collection unit that collects, as the browsing data, the history of browsing of contents taken by the content browsing unit, and sends the history of browsing of contents to the portal server.

In addition, the technology disclosed in Japanese Patent Application Unexamined Publication No. 2005-346318 automatically changes the locations of portlets having been already located, but cannot newly arrange a portlet which provides the function of being a gateway to contents highly frequently browsed by users. Accordingly, in the technology disclosed in Japanese Patent Application Unexamined Publication No. 2005-346318, in order to newly arrange such a portlet, users' customization work and learning work, as described above, have been needed.

Further, the technology disclosed in Japanese Patent Application Unexamined Publication No. 2011-186732 proposes portlets each having a high degree of relevancy with already arranged portlets. But, among portlets each having a low degree of relevancy with already arranged portlets, there still exist some portlets which are capable of providing the function of being a gateway to contents highly frequently browsed by users. Thus, the technology disclosed in Japanese Patent Application Unexamined Publication No. 2011-186732 has not been necessarily a technology which proposes a portlet providing the function of being a gateway to contents highly frequently browsed by users.

Further, the technology disclosed in each of Japanese Patent Application Unexamined Publication No. 2003-345827 and Japanese Patent Application Unexamined Publication No. 2005-284978 automatically indicates a link to contents highly frequently browsed by users on a portal. But, the technology disclosed in each of Japanese Patent Application Unexamined Publication No. 2003-345827 and Japanese Patent Application Unexamined Publication No. 2005-284978 has not been able to newly arrange a portlet which provides the function of being a gateway to contents highly frequently browsed by users.

Further, the technology disclosed in Japanese Patent Application Unexamined Publication No. 2005-12282 incorporates a history of user operations into a recommended content provided by an EPG portlet. But, the technology disclosed in Japanese Patent Application Unexamined Publication No. 2005-12282 is not a technology which arranges such a portlet on a user's portal page.

The present invention enables provision of a technology which provides the function of being a gateway to contents highly frequently browsed by users without imposing any burden on users' work.

Further, part of or the whole of the individual exemplary embodiments can be described in such a way as that of each of the following supplementary notes, but is not limited thereto.

(Supplementary Note 1) A portlet processing apparatus comprising: a browsing data acquisition unit that acquires browsing data representing a user's history of browsing of contents;

a browsing data storage unit that stores said browsing data therein;

a browsing data analysis unit that, on the basis of said browsing data, specifies at least one content of said contents, which is frequently browsed by said user;

a portlet content correspondence information storage unit that, for a portlet which can be arranged on a portal page of said user, store a content correspondence condition for said portlet, representing a condition for specifying a content of said contents, allowed to be referred to on said portlet; and

a portlet recommendation unit that determines a certain content satisfying said content correspondence condition for said portlet, stored in said portlet content correspondence information storage unit, from among said specified at least one content on the basis of said browsing data, and outputs information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

(Supplementary Note 2) The portlet processing apparatus according to supplementary note 1, wherein said browsing data acquisition unit acquires information representing a type of each of said contents by allowing said browsing data to include said information,

and said portlet content correspondence information storage unit stores therein said type of each of said contents by allowing said content correspondence condition to include said type of each of said contents.

(Supplementary Note 3) The portlet processing apparatus according to supplementary note 1 or supplementary note 2, wherein said portlet content correspondence information storage unit further stores, for said portlet, data mapping information representing which data of said content satisfying said content correspondence condition is to be applied to which one of setting items,

said portlet recommendation unit outputs said recommended portlet on which said content satisfying said content correspondence condition for the said portlet is set in accordance with said data mapping information for the said portlet.

(Supplementary Note 4) The portlet processing apparatus according to any one of supplementary note 1 to 3, wherein said browsing data analysis unit specifies, as said at least one content of said contents which is frequently browsed by said user, at least one content of said contents, for which a frequency of browsing performed by the same said user within a predetermined period of time is larger than or equal to a threshold value.

(Supplementary Note 5) The portlet processing apparatus according to any one of supplementary note 1 to 4, wherein said browsing data analysis unit further outputs, for said at least one of said contents which is frequently browsed by said user, a browsing frequency thereof, and

said portlet recommendation unit calculates, for said recommended portlet, a degree of recommendation based on the browsing frequency of said content having been set so as to be allowed to be referred in the said recommended portlet, and outputs said calculated degree of recommendation together with the said recommended portlet.

(Supplementary Note 6) A portal server comprising:

said portlet processing apparatus according to any one of supplementary note 1 to 5;

a recommended portlet storage unit that stores therein said recommended portlet of said user, which is outputted by said portlet processing apparatus;

a personalized information storage unit that stores therein personalized information representing said portlet arranged on said portal page of said user;

a portal page creation unit that creates said portal page of said user on the basis of said recommended portlet stored in said recommended portlet storage unit, and said personalized information stored in said personalized information storage unit; and

a request responding unit that, in response to a request from a client apparatus, sends said portal page having been created by said portal page creation unit.

(Supplementary Note 7) The portal server according to claim 6, further comprising:

a portal page customization unit that acquires information in relation to customization of said recommended portlet on said portal page having been created by said portal page creation unit, and updates said personalized information stored in said personalized information storage unit on the basis of said acquired information.

(Supplementary Note 8) The portal server according to supplementary note 6 or supplementary note 7, wherein, in the case where said portlet processing apparatus is an apparatus as set forth in supplementary note 5, said portal page creation unit arranges said recommended portlet on said portal page on the basis of said degree of recommendation.

(Supplementary Note 9) A portal system comprising:

said portal server according to any one of supplementary note 6 to 8; and said client apparatus,

wherein said client apparatus includes

a content browsing unit that acquires and outputs said content from a content provision source of said content, and acquires said portal page by sending said request for said portal page to said portal server and outputs the acquired said content, and

a browsing data collection unit that collects, as said browsing data, said history of browsing of contents taken by said content browsing unit, and sends the said history of browsing of contents to said portal server.

(Supplementary Note 10) A portlet processing method comprising:

acquiring browsing data representing a user's history of browsing of contents;

on the basis of said browsing data, specifying at least one content of said contents, which is frequently browsed by said user;

for a portlet which can be arranged on a portal page of said user, by retaining a content correspondence condition for said portlet, representing a condition for specifying a content of said contents, allowed to be referred to on said portlet, determining a certain content satisfying said content correspondence condition for said portlet from among said specified at least one content on the basis of said browsing data; and

outputting information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

(Supplementary Note 11) A nonvolatile recording medium recording a computer program which causes a computer to execute the processing comprising the steps of;

a browsing data acquisition step of acquiring browsing data representing a user's history of browsing of contents;

a browsing data analysis step of, on the basis of said browsing data, specifying at least one content of said contents, which is frequently browsed by said user; and

a portlet recommendation step of, for a portlet which can be arranged on a portal page of said user, by retaining a content correspondence condition for said portlet, representing a condition for specifying a content of said contents, allowed to be referred to on said portlet, determining a certain content satisfying said content correspondence condition for said portlet from among said specified at least one content on the basis of said browsing data, and

outputting information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

(Supplementary Note 12) A portlet processing apparatus comprising: browsing data acquisition means for acquiring browsing data representing a user's history of browsing of contents;

browsing data storage means for storing said browsing data therein;

browsing data analysis means for, on the basis of said browsing data, specifying at least one content of said contents which is frequently browsed by said user;

portlet content correspondence information storage means for, for a portlet which can be arranged on a portal page of said user, store a content correspondence condition for said portlet, representing a condition for specifying a content of said contents, allowed to be referred to on said portlet; and

portlet recommendation means for determines a certain content satisfying said content correspondence condition for said portlet, stored in said portlet content correspondence information storage unit, from among said specified at least one content on the basis of said browsing data, and outputting information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

### DESCRIPTION OF SYMBOL

1 Portlet processing apparatus
2 Portal system
3 Group portal-page development work supporting system
20, 50 Portal server
30 Client apparatus
40 Content provision source apparatus
101, 501 Browsing data acquisition unit
102 Browsing data storage unit
103, 503 Browsing data analysis unit
104 Portlet content correspondence information storage unit
105, 505 Portlet recommendation unit
22 Personalized information storage unit
23, 53 Portal page creation unit
24 Request responding unit
25, 55 Recommended portlet storage unit
31 Browsing data collection unit
32 Content browsing unit
56 Portal page customization unit
1001 CPU
1002 RAM
1003 ROM
1004 Storage device
1005 Network interface
1007 Recording medium

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A portlet processing apparatus comprising: a browsing data acquisition unit that acquires browsing data representing a user's history of browsing of contents;
a browsing data storage unit that stores said browsing data therein;
a browsing data analysis unit that, on the basis of said browsing data, specifies at least one content of said contents, which is frequently browsed by said user;
a portlet content correspondence information storage unit that, for a portlet which can be arranged on a portal page of said user, store a content correspondence condition for said portlet, representing a condition for specifying a content of said contents, allowed to be referred to on said portlet; and
a portlet recommendation unit that determines a certain content satisfying said content correspondence condition for said portlet, stored in said portlet content correspondence information storage unit, from among said specified at least one content on the basis of said browsing data, and outputs information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

2. The portlet processing apparatus according to claim 1, wherein said browsing data acquisition unit acquires information representing a type of each of said contents by allowing said browsing data to include said information,
and said portlet content correspondence information storage unit stores therein said type of each of said contents by allowing said content correspondence condition to include said type of each of said contents.

3. The portlet processing apparatus according to claim 1, wherein said portlet content correspondence information storage unit further stores, for said portlet, data mapping information representing which data of said content satisfying said content correspondence condition is to be applied to which one of setting items,
said portlet recommendation unit outputs said recommended portlet on which said content satisfying said content correspondence condition for the said portlet is set in accordance with said data mapping information for the said portlet.

4. The portlet processing apparatus according to claim 1, wherein said browsing data analysis unit specifies, as said at least one content of said contents which is frequently browsed by said user, at least one content of said contents, for which a frequency of browsing performed by the same said user within a predetermined period of time is larger than or equal to a threshold value.

5. The portlet processing apparatus according to claim 1, wherein said browsing data analysis unit further outputs, for said at least one of said contents which is frequently browsed by said user, a browsing frequency thereof, and
said portlet recommendation unit calculates, for said recommended portlet, a degree of recommendation based on the browsing frequency of said content having been set so as to be allowed to be referred in the said recommended portlet, and outputs said calculated degree of recommendation together with the said recommended portlet.

6. A portlet processing method comprising:
acquiring browsing data representing a user's history of browsing of contents;
on the basis of said browsing data, specifying at least one content of said contents, which is frequently browsed by said user;
for a portlet which can be arranged on a portal page of said user, by retaining a content correspondence condition for said portlet, representing a condition for specifying a content of said contents, allowed to be referred to on said portlet, determining a certain content satisfying said content correspondence condition for said portlet from among said specified at least one content on the basis of said browsing data; and
outputting information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.

7. A nonvolatile recording medium recording a computer program which causes a computer to execute the processing comprising the steps of;
a browsing data acquisition step of acquiring browsing data representing a user's history of browsing of contents;
a browsing data analysis step of, on the basis of said browsing data, specifying at least one content of said contents, which is frequently browsed by said user; and
a portlet recommendation step of, for a portlet which can be arranged on a portal page of said user, by retaining a content correspondence condition for said portlet, representing a condition for specifying a content of said contents, allowed to be referred to on said portlet, determining a certain content satisfying said content correspondence condition for said portlet from among said specified at least one content on the basis of said browsing data, and
outputting information representing said portlet on which said certain content having been determined as a content satisfying said content correspondence condition for said portlet is set so as to be allowed to be referred to, the information being outputted as a recommended portlet which is recommended to be arranged on said portal page of said user who has browsed said certain content.
